(19) United States
(12) Patent Application Publication
(10) Pub. No.: US 2023/0323886 A1
(43) Pub. Date: Oct. 12, 2023

(54) TWO STAGE MIXED-FLOW COMPRESSOR

(71) Applicant: Carrier Corporation, Palm Beach Gardens, FL (US)

(72) Inventor: Vishnu Sishtla, Syracuse, NY (US)

(21) Appl. No.: 18/297,764

(22) Filed: Apr. 10, 2023

Related U.S. Application Data
(60) Provisional application No. 63/329,731, filed on Apr. 11, 2022.

(51) Int. Cl. F04D 17/12; F04D 29/28; F04D 29/44; F04D 25/06

(52) U.S. Cl. CPC F04D 17/12; F04D 29/286; F04D 29/444; F04D 25/0606

(57) ABSTRACT

A compressor is provided including a housing. A first compression stage is defined within the housing and a second compression stage is defined within the housing. The first compression stage has a first compression component and the second compression stage has a second compression component. Both the first compression stage and the second compression stage have a mixed-flow configuration. A motor section is disposed between the first compression stage and the second compression stage relative to a fluid flow through the compressor.

### CROSS-REFERENCE TO RELATED APPLICATIONS

This application claims the benefit of U.S. Application No. 63/329,731, filed Apr. 11, 2022, the contents of which are incorporated by reference herein in their entirety.

### BACKGROUND

Embodiments of the disclosure relate generally to a compressor of a refrigeration system, and more particularly, to multi-stage compressor of a refrigeration system.

Rotary machines are commonly used in refrigeration and turbine applications. An example of a rotary machine includes a centrifugal compressor having an impeller fixed to a rotating shaft. Rotation of the impeller increases a pressure and/or velocity of a fluid or gas moving across the impeller.

In applications using new low-pressure refrigerants, the overall diameter of the compressor is typically large to accommodate the high speeds. However, these large sizes may exceed the available space within a packaging envelope. There is therefore a need to develop a compressor having a reduced footprint and suitable for use in low pressure refrigerant applications.

### BRIEF DESCRIPTION

According to an embodiment, a compressor is provided including a housing. A first compression stage is defined within the housing and a second compression stage is defined within the housing. The first compression stage has a first compression component and the second compression stage has a second compression component. Both the first compression stage and the second compression stage have a mixed-flow configuration. A motor section is disposed between the first compression stage and the second compression stage relative to a fluid flow through the compressor.

In addition to one or more of the features described above, or as an alternative, in further embodiments the first compression component and the second compression component are coaxial.

In addition to one or more of the features described above, or as an alternative, in further embodiments the motor section further comprises a stator and a rotor connected to a drive shaft. The first compression component and the second compression component are mounted to the drive shaft.

In addition to one or more of the features described above, or as an alternative, in further embodiments the second compression component further comprises an inlet and an outlet. The second compression component is mounted to the drive shaft such that the inlet is positioned closer to the motor section than the outlet.

In addition to one or more of the features described above, or as an alternative, in further embodiments the first compression component is a first impeller and the second compression component is a second impeller. The second impeller has a different configuration than the first impeller.

In addition to one or more of the features described above, or as an alternative, in further embodiments at least one of the first impeller and the second impeller further comprises a hub having a front side and a back side. The hub is rotatable about an axis of rotation and a plurality of vanes extend outwardly from the front side of the hub such that a plurality of passages are defined between adjacent vanes of the plurality of vanes. The fluid flow is output from the plurality of passages adjacent to the back side of the hub.

In addition to one or more of the features described above, or as an alternative, in further embodiments the flow output from the plurality of passages adjacent to the back side of the hub the is at an angle relative to the axis of rotation, the angle being less than 20 degrees.

In addition to one or more of the features described above, or as an alternative, in further embodiments the angle of the flow output from the plurality of passages is parallel to the axis of rotation.

In addition to one or more of the features described above, or as an alternative, in further embodiments comprising a volute arranged downstream from an outlet of the second compression component relative to an axis of rotation of the second compression component.

In addition to one or more of the features described above, or as an alternative, in further embodiments comprising at least one diffuser section. The at least one diffuser section is arranged within the housing at a position axially downstream from an outlet of the first compression component.

In addition to one or more of the features described above, or as an alternative, in further embodiments the at least one diffuser section further comprises: a diffuser structure and an axial flow passage defined between an interior surface of the housing and the diffuser structure.

In addition to one or more of the features described above, or as an alternative, in further embodiments the diffuser structure is rotationally fixed.

In addition to one or more of the features described above, or as an alternative, in further embodiments comprising a plurality of vanes arranged within the axial flow passage.

in addition to one or more of the features described above, or as an alternative, in further embodiments the at least one diffuser section further comprises: a first diffuser section arranged within the housing at a first position directly downstream from an outlet of the first compression component and a second diffuser section arranged within the housing at a second position directly downstream from an outlet of the second compression component.

In addition to one or more of the features described above, or as an alternative, in further embodiments the first compression stage and the second compression stage are arranged in series relative to the fluid flow and a fluid flow path extends from an inlet of the first compression stage to an outlet of the second compression stage. The fluid flow path is arranged within the housing.

In addition to one or more of the features described above, or as an alternative, in further embodiments the motor section further comprises a stator and a rotor, the fluid flow path extending between the stator and an adjacent portion of the housing.

In addition to one or more of the features described above, or as an alternative, in further embodiments the fluid flow path extending between an outlet of the motor section and an inlet of the second compression stage has a non-linear configuration.

in addition to one or more of the features described above, or as an alternative, in further embodiments the fluid flow path extending between the outlet of the motor section and the inlet of the second compression stage has a sloped configuration.

In addition to one or more of the features described above, or as an alternative, in further embodiments a diameter of the housing associated with the second compression stage varies between the outlet of the motor section and the inlet of the second compression component.

### BRIEF DESCRIPTION OF THE DRAWINGS

The following descriptions should not be considered limiting in any way. With reference to the accompanying drawings, like elements are numbered alike:

FIG. 1 is a side view of an exemplary multi-stage compressor according to an embodiment;

FIG. 2 is a cross-sectional view of the exemplary multi-stage compressor of FIG. 1 according to an embodiment;

FIG. 3A is a perspective view of an exemplary mixed-flow impeller of the multi-stage compressor of FIG. 1 according to an embodiment;

FIG. 3B is a cross-sectional view of the mixed-flow impeller of FIG. 3A according to an embodiment; and

FIG. 4 is a perspective view of an exemplary diffuser structure of the multi-stage compressor of FIG. 1 according to an embodiment.

### DETAILED DESCRIPTION

A detailed description of one or more embodiments of the disclosed apparatus and method are presented herein by way of exemplification and not limitation with reference to the Figures.

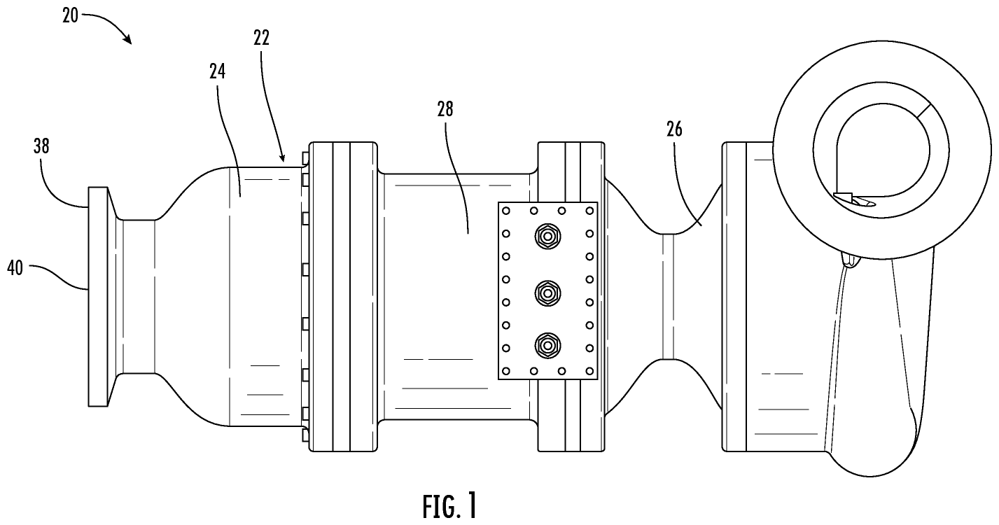

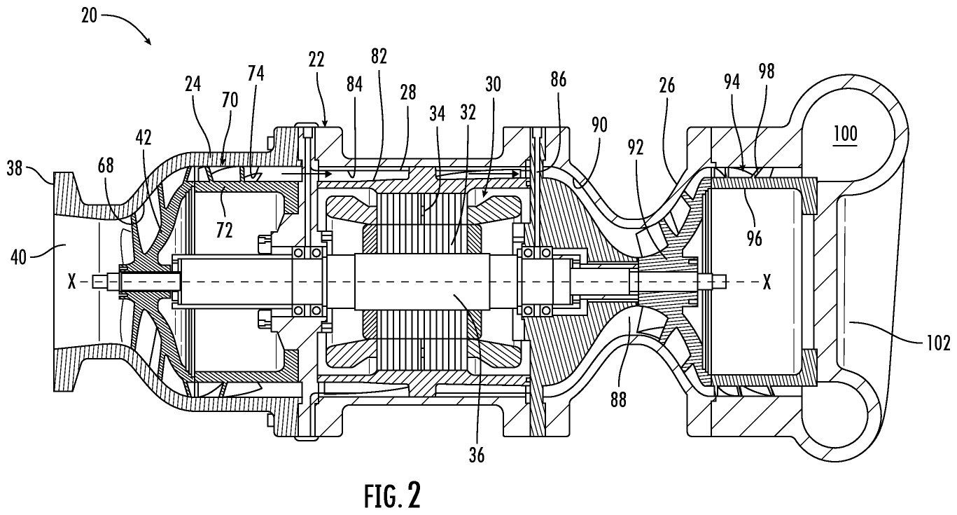

Referring now to FIGS. 1 and 2, an exemplary multi-stage compressor 20, such as a two-stage compressor for example, is illustrated. As shown, the compressor 20 includes a housing 22 that defines not only a first compression stage, and a second compression stage, but also defines a motor section. Accordingly, in an embodiment, the housing 22 includes a main casing 24 associated with the first stage, a secondary casing 26 associated with the second stage, and a motor casing 28 disposed axially between the main casing 24 and the secondary casing 26. Mounted within the motor casing 28 is a motor 30 including a rotor 32 and a stator 34. In the illustrated, non-limiting embodiment, the rotor 32 is mounted at least partially within the stator 34, such as concentrically therewith, and is coupled to a drive shaft 36 rotatable about an axis X.

The main casing 24 includes an inlet 40 formed at a first end 38 thereof operable to direct a fluid, such as refrigerant for example, into the compressor 20. In an embodiment, a plurality of adjustable inlet guide vanes (not shown) may be arranged adjacent to the inlet. 40 to control the flow of fluid into the compressor 20. The first stage of the compressor 20 includes a first compression component 42, such as an impeller for example, mounted within the interior of the main casing 24. The first impeller 42 is secured to the drive shaft 36 of the motor 30 via any suitable coupling mechanism (not shown) such that the impeller 42 is coaxial with the axis X of the motor 30. In operation, the fluid provided to the first stage of the compressor 20 via the inlet 40 is directed axially toward the rotating impeller 42.

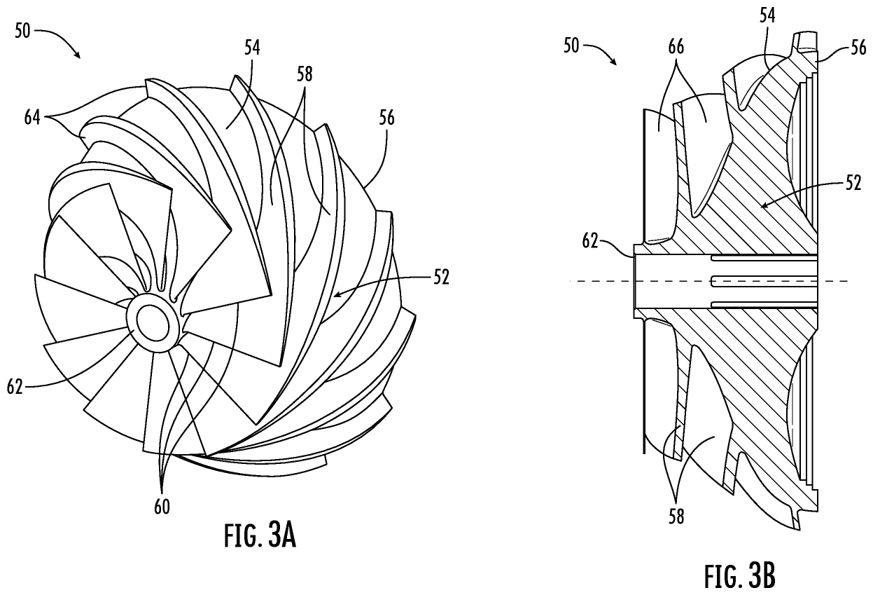

With reference now to FIG. 3A and 3B, an exemplary impeller 50 suitable for use as the first compression component 42 is illustrated. In the illustrated, non-limiting embodiment, the impeller 50 has a mixed-flow configuration, which moves the fluid in both an axial and radial direction discharges the fluid therefrom in an axial direction, to be described in more detail below. As shown, the impeller 50 includes a hub or body 52 having a front side 54 and a back side 56. The diameter of the front side 54 of the body 52 may generally increase toward the back side 56 such that the impeller 50 is generally conical in shape. A plurality of blades or vanes 58 extends radially outwardly from the body 52. Each of the plurality of blades 58 is arranged at an angle to the axis of rotation X of the drive shaft 36 and the impeller 50. In an embodiment, each of the blades 58 extends along at least a portion of the front side 54 to the back side 56 of the impeller 50. As shown, each blade 58 includes a first end 60 arranged generally adjacent to a first end 62 of the hub 52 and a second end 64 located generally adjacent the back side 56 of the impeller 50, such as at the intersection between the front side 54 and the back side 56 for example. Further, the second end 64 of one or more of the blades 58 is circumferentially offset from the corresponding first end 60 of a respective blade 58.

A plurality of passages 66 is defined between adjacent blades 58 to discharge a fluid passing over the impeller 50 generally parallel to the axis X. As the impeller 50 rotates, fluid approaches the first end 62 of the impeller 50 in a substantially axial direction and flows through the passages 66 defined between adjacent blades 58. Because the passages 66 have both an axial and radial component, the axial flow provided to the front surface 54 of the impeller 50 simultaneously moves both parallel to and circumferentially about the axis X of the shaft 36. When the impeller 50 is used as the first compression component 42 of the compressor, the inner surface 68 of the main casing 24 surrounding the impeller 50 and the passages 66 of the impeller 50, in combination, cooperate to discharge the compressed refrigerant fluid from the impeller 50. In an embodiment, the compressed fluid is discharged from the impeller 50 at any angle relative to the axis X of the shaft 36 into an adjacent diffuser section 70, The angle may between 0°, generally parallel to the axis of rotation X of the shaft, and less than 90°, less than 75°, less than 60°, less than 45°, less than 30°, less than 20°, less than 10°, or less than 5° for example.

In the illustrated, non-limiting embodiment, the impeller 50 is an unshrouded or open impeller. As used herein, the term “unshrouded” or “open” impeller may refer to configurations of an impeller where a portion of the housing that does not rotate with the impeller and has a clearance relative to the impeller forms a shroud about at least a portion of the impeller. However, it should be understood that embodiments where the impeller 50 is a shrouded impeller are also contemplated herein. In a shrouded impeller, the shroud is configured to rotate with the impeller, and in sonic embodiments, may he integrally formed with the impeller.

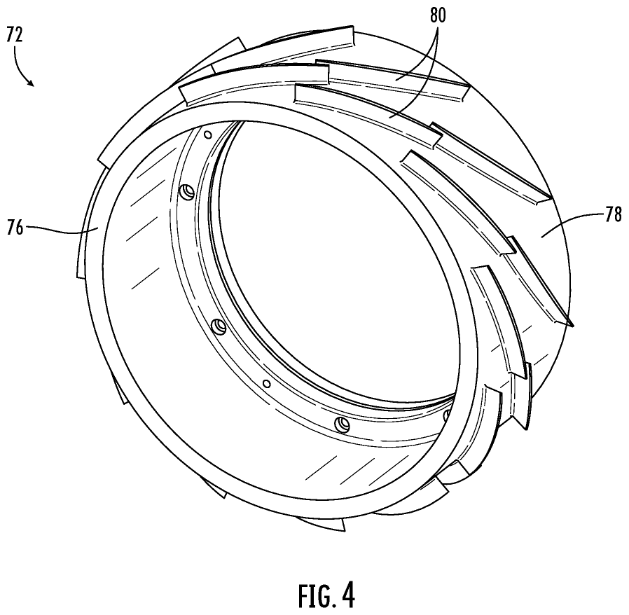

After the fluid is accelerated by the impeller 50, at least one downstream diffuser section 70 may be used to decelerate the fluid while converting kinetic energy to pressure energy. As shown, the diffuser section 70 is defined adjacent a downstream end of the impeller body 52 relative to the direction of flow through the compressor 20. In the illustrated, non-limiting embodiment, the diffuser section 70 has an axial flow passage oriented substantially parallel to the rotational axis X of the impeller 42. Within the diffuser section 70, the axial flow passage may be defined between a diffuser structure 72 and the interior surface 74 of the adjacent portion of the compressor housing, such as the main casing 24 for example. With continued reference to FIG. 2 and further reference to FIG. 4, an example of a diffuser structure is provided. As shown, the diffuser structure 72 is generally tubular or cylindrical in shape and is fixed relative to the axis X. When the diffuser structure 72 is mounted within the compressor 20, a first end 76 of the diffuser structure 72 may directly abut the back side 56 of the impeller 50. Further, the diffuser structure 72 may be mounted such that an outer surface 78 thereof is substantially flush with the front side 54 of the impeller 50 at the interface with the back side 56. In this configuration, the fluid flow through the compressor 20 smoothly transitions from the outlet of the impeller 50 to the coaxial fluid flow path of the diffuser section 70. The diffuser section 70 may have a vaneless configuration, or alternatively, may include a plurality of vanes 80 extending from one or both of the body of the diffuser structure 72 and the interior surface 74 of the main casing 24.

The axial flow path extending through the diffuser section 70 directs the compressed fluid flow toward the motor section of the compressor 20. Within the motor section, a fluid flow path may be defined between an exterior surface 82 of the motor stator 34 and an interior surface 84 of the motor casing 28 surrounding the adjacent motor 30. In the illustrated, non-limiting embodiment, the flow path has a generally axial configuration and is generally aligned and coaxial with the flow channel defined between the diffuser structure 72 and the housing 22. It should be understood that the flow path illustrated and described herein is intended as an example, and that other suitable flow paths may extend through the motor section of the compressor 20.

From the motor section of the compressor 20, the fluid flow is provided to the second stage of the compressor 20, located downstream from the motor 30 within the secondary casing 26. The flow path between the outlet 86 of the motor casing 28 and the inlet 88 of the second stage of the compressor 20 may have a non-linear configuration. In the illustrated, non-limiting embodiment, the flow path slopes from adjacent the interior surface 90 of the secondary casing 26, axially aligned with the fluid flow path within the motor section, toward the center of the interior of the secondary casing 26, and the axis X of the drive shaft 36. In operation, the fluid flow provided at the inlet 88 of the second stage is also generally axial. In the illustrated, non-limiting embodiment, a diameter of the secondary casing 26 decreases from directly adjacent the motor casing 28 to the inlet of the secondary stage. However, embodiments where the secondary casing 26 has another configuration are also within the scope of the disclosure.

The compression component 92 of the second stage is similar to the compression component 42 of the first stage of the compressor 20. More specifically, in an embodiment, the compression component 92 of the second stage is also a mixed-flow impeller, similar to impeller 50. Accordingly, the flow output from the second compression component 92 has a generally axial configuration. However, one or more parameters of the second compression component 92 may be different than the first compression component 42, resulting in a different configuration of the first and second compression components, to achieve a different compression ratio within each stage of the compressor 20. The second impeller 92 is secured to a portion of the drive shaft 36 via any suitable coupling mechanism (not shown) such that the impeller 92 is coaxial with the axis X of the motor 30 and the first compression component 42.

In an embodiment, a second diffuser 94 having an axial flow path is arranged downstream from an outlet of the second compression component 92 and is used to decelerate the further compressed fluid. Similar to the first diffuser section 70, a flow path may extend between a second diffuser structure 96 and an interior surface 98 of the adjacent portion of the secondary casing 26. The diffuser structure 96 may but need not directly abut the back side of the impeller 92 and may be mounted such that an outer surface thereof is substantially flush with the front side of the impeller 92 at the interface with the back side. In the illustrated, non-limiting embodiment, the second diffuser section 94 functions to direct the compressed fluid into a toroidal--shaped volute 100 arranged at the second, opposite end 102 of the compressor 20. The volute 100 may be configured to direct the compressed fluid toward a compressor outlet, or in other embodiments, towards another stage of the compressor.

A compressor 40 as illustrated and described herein is suitable for use with any type of refrigerant and may be particularly useful with low or medium pressure refrigerants. Low pressure refrigerants typically have evaporator pressure lower than atmospheric pressure and medium pressure refrigerants typically have evaporator pressure above atmospheric pressure. In addition, by having two mixed-flow compression stages, a continuous fluid flow path extends between the first and second stages, generally parallel to the axis X between the first and second ends 38, 102 of the compressor housing 22. Furthermore, the entirety of the fluid flow path may be defined or formed completely within the interior of the housing 22.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A compressor comprising:
a housing;
a first compression stage defined within the housing, the first compression stage having a first compression component;
a second compression stage defined within the housing, the second compression stage having a second compression component, wherein both the first compression stage and the second compression stage have a mixed-flow configuration; and
a motor section disposed between the first compression stage and the second compression stage relative to a fluid flow through the compressor.

2. The compressor of claim 1, wherein the first compression component and the second compression component are coaxial.

3. The compressor of claim 2, wherein the motor section further comprises a stator and a rotor connected to a drive shaft, wherein the first compression component and the second compression component are mounted to the drive shaft.

4. The compressor of claim 3, wherein the second compression component further comprises an inlet and an outlet, the second compression component being mounted to the drive shaft such that the inlet is positioned closer to the motor section than the outlet.

5. The compressor of claim 1, wherein the first compression component is a first impeller and the second compression component is a second impeller, the second impeller having a different configuration than the first impeller.

6. The compressor of claim 5, wherein at least one of the first impeller and the second impeller further comprises:
a hub having a front side and a back side, the hub being rotatable about an axis of rotation;
a plurality of vanes extending outwardly from the front side of the hub such that a plurality of passages are defined between adjacent vanes of the plurality of vanes, the fluid flow being output from the plurality of passages adjacent to the back side of the hub.

7. The compressor of claim 6, wherein the flow output from the plurality of passages adjacent to the back side of the hub the is at an angle relative to the axis of rotation, the angle being less than 20 degrees.

8. The compressor of claim 7, wherein the angle of the flow output from the plurality of passages is parallel to the axis of rotation.

9. The compressor of claim 1, further comprising a volute arranged downstream from an outlet of the second compression component relative to an axis of rotation of the second compression component.

10. The compressor of claim 1, further comprising at least one diffuser section, the at least one diffuser section being arranged within the housing at a position axially downstream from an outlet of the first compression component.

11. The compressor of claim 10, wherein the at least one diffuser section further comprises:
a diffuser structure; and
an axial flow passage defined between an interior surface of the housing and the diffuser structure.

12. The compressor of claim 11, wherein the diffuser structure is rotationally fixed.

13. The compressor of claim 11, further comprising a plurality of vanes arranged within the axial flow passage.

14. The compressor of claim 10, wherein the at least one diffuser section further comprises:
a first diffuser section arranged within the housing at a first position directly downstream from an outlet of the first compression component; and
a second diffuser section arranged within the housing at a second position directly downstream from an outlet of the second compression component.

15. The compressor of claim 1, wherein the first compression stage and the second compression stage are arranged in series relative to the fluid flow and a fluid flow path extends from an inlet of the first compression stage to an outlet of the second compression stage, wherein the fluid flow path is arranged within the housing.

16. The compressor of claim 15, wherein the motor section further comprises a stator and a rotor, the fluid flow path extending between the stator and an adjacent portion of the housing.

17. The compressor of claim 16, wherein the fluid flow path extending between an outlet of the motor section and an inlet of the second compression stage has a non-linear configuration.

18. The compressor of claim 16, wherein the fluid flow path extending between the outlet of the motor section and the inlet of the second compression stage has a sloped configuration.

19. The compressor of claim 17, wherein a diameter of the housing associated with the second compression stage varies between the outlet of the motor section and the inlet of the second compression component.
